(19) United States
(12) Patent Application Publication
(10) Pub. No.: US 2026/0030047 A1
(43) Pub. Date: Jan. 29, 2026

(54) SERVERLESS CLOUD COMPUTING

(71) Applicant: FMR LLC, Boston, MA (US)

(72) Inventors: Vivekraj Rangaswamy Cheluvaraju, Morrisville, NC (US); Subramanya Raju Janardhana Raju, Karnataka (IN)

(21) Appl. No.: 18/785,800

(22) Filed: Jul. 26, 2024

(51) Int. Cl. G06F 9/455; G06F 11/14

(52) U.S. Cl. CPC G06F 9/45558; G06F 11/1405; G06F 2009/45595; G06F 2201/81

(57) ABSTRACT

A computerized method is provided for batch processing in an on-demand cloud computing or serverless environment. Methods can include using a serverless event bus to trigger a workflow and a serverless workflow orchestration system to manage the workflow in a specified order among a number of containerized applications. In particular embodiments, serverless batch processing may be used to facilitate passage and reconciliation of data between disparate programs such as employee time entry, scheduling, and HR/payroll systems.

### TECHNICAL FIELD

This application relates generally to systems, methods, and apparatuses, including computer program products, for serverless batch processing.

### BACKGROUND

Enterprise computing often requires passing data between multiple disparate software, systems, and environments in order to integrate different processes and accomplish business tasks. For example, a company may use one program for associate time entry and time off/scheduling and another program for human resources/payroll. The software for these functions can be on premises or remotely hosted or even serverless. Integrating these systems, especially in an efficient manner for routine batch processing, can be difficult and time- and resource-intensive.

### SUMMARY

Systems and methods described herein provide serverless batch processing for regular integration of data across platforms and programs. As applied to the situation discussed above, applications in an on-demand cloud computing environment, including off-the-shelf programs can be leveraged to run repeatable batch processing tasks such as time off requests and time entry by managing regular communication and reconciliation between disparate programs managing time entry and time off requests and those managing HR and payroll. In various embodiments, the on-demand cloud computing environment may host an event bus, a workflow orchestration system, and one or more containerized applications. The even bus can initiate or trigger a batch processing job that consists of a workflow of serial operations performed in a determined order. Each of the containerized applications can be dedicated to performing a step in that workflow and the workflow can be managed by the workflow orchestration system. In various embodiments, the workflow can be used to manipulate data and facilitate communication and reconciliation between two or more programs or systems such as on-premises software for time entry and HR management.

Aspects of the invention can include a computerized method batch processing in an on-demand cloud computing environment comprising an event bus, a workflow orchestration service, and a plurality of containerized applications. Methods can include initiating a workflow using the event bus; performing an initial operation of the workflow on a starting data set using one of the plurality of containerized applications; performing a series of dependent operations in a specified order using the plurality of containerized applications wherein the series of dependent operations are performed by one of the plurality of containerized applications using an output by another of the plurality of containerized applications; performing a last of the series of dependent operations by a last of the plurality of containerized applications to generate a final output; and discontinuing the workflow using the event bus after generation of the final output.

In some embodiments, methods can include monitoring each of the plurality of containerized applications and retrying the dependent operation until the dependent operation successfully completes or a threshold retry limit is reached. The monitoring and retrying steps may be performed by the workflow orchestration service. The monitoring and retrying steps can be performed by each of the plurality of containerized applications. Methods may include performing a recovery action when the threshold retry limit is reached. The recovery action may include sending a failure notification, logging a failure notification in a database.

In some embodiments, the event bus can comprise AWS EventBridge, the workflow orchestration service comprises AWS Step Functions, and one or more of the containerized applications are executed using AWS Fargate. The distributed batch processing may comprise time off and payroll processing and the event bus initiates the workflow at regular intervals. The starting data set can include time worked and time off requests entered by users since the workflow was last initiated. The initial operation performed by a first of the plurality of containerized applications can include retrieving the starting data set from a time entry program using an application programming interface to communicate with the time entry program and updating a time entered database with the starting data. A first of the series of successive, dependent operations can then retrieve time entered data from the time entered database; retrieves time worked and time off approvals from a time approval program using a web service; reconciles the time entered data with the time worked and time off approvals to create a final payroll record; and saves the final payroll record to a payroll database. The last of the series of dependent operations can comprise retrieving the final payroll record from the payroll database; formatting the final payroll record in an acceptable format for a payroll program; and sending the formatted final payroll record to the payroll program as the final output. In various embodiments, the regular intervals may be hourly.

In certain aspects, systems of the invention can include a computer system for batch processing. The system can include an on-demand cloud computing environment, an event bus, a workflow orchestration service, and a plurality of containerized applications. The event bus may be operable to initiate a workflow and the workflow orchestration service is operable to control the workflow and stop the workflow after generation of a final output. The workflow can comprise performing an initial operation on a starting data set followed by a series of successive, dependent operations, in a specified order, using the plurality of containerized applications. Each of the series of dependent operations may be performed by one of the plurality of containerized applications using an output by another of the plurality of containerized applications. A last of the series of dependent operations performed by a last of the plurality of containerized applications can then generate the final output.

In various embodiments systems of the invention can be operable to perform any and all of the aforementioned methods.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for batch processing in an on-demand cloud computing environment.

FIG. 2 shows an exemplary method for batch processing in an on-demand cloud computing environment.

FIG. 3 shows an exemplary batch processing workflow according to various embodiments.

FIG. 4 shows an exemplary batch processing workflow for processing time paid time off requests.

FIG. 5 shows an exemplary system organized in the AWS Lambda environment for serverless batch processing.

FIG. 6 shows redundancy in an exemplary system organized in the AWS Lambda environment for serverless batch processing.

### DETAILED DESCRIPTION

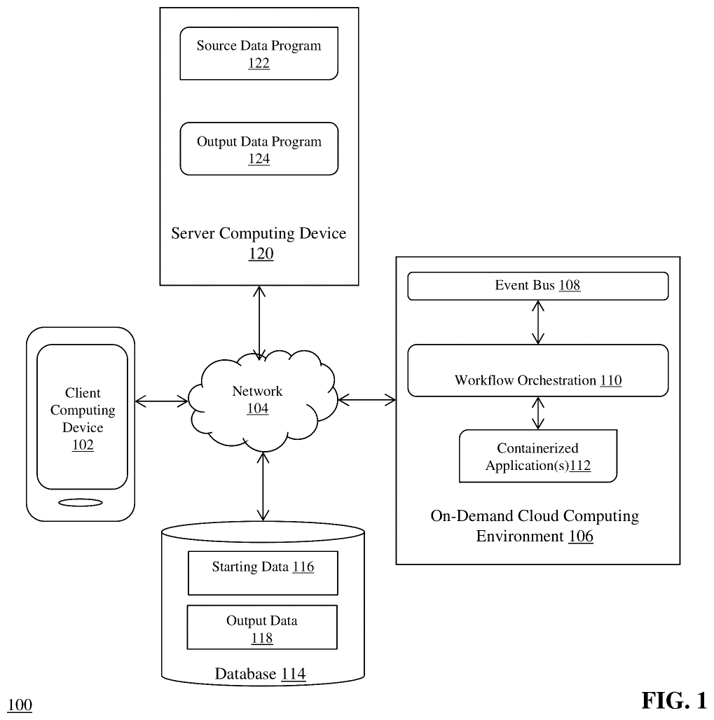

FIG. 1 is a block diagram of an exemplary system 100 for serverless batch processing. The system 100 includes a client computing device 102, a communications network 104, a server computing device 120 that includes source data program 122 from which the system pulls initial data for batch processing and an output data program 124 that receives the final output data resulting from the batch processing steps, a database 114 that includes starting data 116 taken from the source data program and output data 118 accessed and used by the output data program. The system 100 also includes an on-demand cloud computing or serverless computing environment 106 in which modules including an event bus 108, a workflow orchestration module 110, and a plurality of containerized applications 112 operate.

The client computing device 102 connects to one or more communications networks (e.g., network 104) in order to communicate with the server computing device 106 to provide input and receive output relating to the source data program 122 and the output data program 124. For example, the batch processing performed by the depicted system can include time entry and payroll processing wherein the source data program 122 is a time entry program through which an associate enters their time worked, views their upcoming work schedule, and requests time off. The output data program 124 may be an HR program through which associates or managers review and approve entered time and time off requests. Associates and managers may interact with the programs (e.g., entering time, requesting time off, and approving time) via a client computing device 102.

Exemplary client computing devices 102 include but are not limited to server computing devices, desktop computers, laptop computers, tablets, mobile devices, smartphones, and the like. Typically, the client computing device 102 includes a display device (not shown) that is embedded in and/or coupled to the client computing device for the purpose of displaying information to a user of the device. It should be appreciated that other types of computing devices that are capable of connecting to the components of the system 100 can be used without departing from the scope of invention. Although FIG. 1 depicts one client computing device 102, it should be appreciated that the system 100 can include any number of client computing devices.

In some embodiments, the client computing device 102 can execute one or more software applications that are used to provide input to and receive output from the server computing device 106. For example, the client computing device 102 can be configured to execute one or more native applications and/or one or more browser applications. Generally, a native application is a software application (in some cases, called an ‘app’) that is installed locally on the client computing device 102 and written with programmatic code designed to interact with an operating system that is native to the client computing device 102. Such software may be available from, e.g., the Apple® App Store, the Google® Play Store, the Microsoft® Store, or other software download platforms depending upon, e.g., the type of device used. In some embodiments, the native application includes a software development kit (SDK) module that is executed by a processor of the client computing device 102 to perform functions (e.g., enter or approve time worked or request time off). Generally, a browser application comprises software executing on a processor of the client computing device 102 that enables the client computing device to communicate via HTTP or HTTPS with remote servers addressable with URLs (e.g., server computing device 106) to receive website-related content, including one or more webpages, for rendering in the browser application and presentation on the display device coupled to the client computing device 102. Exemplary mobile browser application software includes, but is not limited to, Firefox™, Chrome™, Safari™, and other similar software. The one or more webpages can comprise visual and audio content for display to and interaction with a user.

The communications network 104 enables the client computing device 102 to communicate with the server computing device 106. The network 104 is typically comprised of one or more wide area networks, such as the Internet and/or a cellular network, and/or local area networks. In some embodiments, the network 104 is comprised of several discrete networks and/or sub-networks (e.g., cellular to Internet).

The server computing device 120 is a device including specialized hardware and/or software modules that execute on a processor and interact with memory modules of the server computing device 120, to receive data from other components of the system 100, transmit data to other components of the system 100, and perform functions (e.g., time entry, scheduling, and payroll management as discussed above). As discussed above the server computing device 120 includes the source data program 122 and the output data program 124 and any number of other programs that may execute on the processor of the server computing device 120 and may each, despite being disparate programs, rely on a regular exchange of data between them. In the example discussed above, the HR program may rely on the time entry and scheduling data entered by the associate in the time entry program. Due to the haphazard timing of associate time entry and scheduling requests it is difficult to efficiently capture and transfer that data, especially between disparate programs. In some embodiments, the modules 122 and 124 are specialized sets of computer software instructions programmed onto one or more dedicated processors in the server computing device 120 and can include specifically designated memory locations and/or registers for executing the specialized computer software instructions.

Although the computing modules 122 and 124 are shown in FIG. 1 as executing within the same server computing device 120, in some embodiments the functionality of the computing modules 122 and 124 can be distributed among a plurality of server computing devices. It should be appreciated that any number of computing devices, arranged in a variety of architectures, resources, and configurations (e.g., cluster computing, virtual computing, cloud computing) can be used without departing from the scope of the invention. The exemplary functionality of the computing modules 122 and 124 is described in detail throughout this specification.

The database 114 is a computing device (or in some embodiments, a set of computing devices) coupled to the server computing device 120 and the serverless programs or modules (108, 110, and 112) in the on-demand cloud computing environment 106 (in some embodiments, via communications network 104) and is configured to receive, generate, and store specific segments of data relating to performing batch processing on data retrieved from or used by the source data program 122 or output data program 124 on the server computing device 120. In some embodiments, all or a portion of the database 114 can be integrated with the server computing device 120 or be located on a separate computing device or devices. The database 114 can comprise one or more databases configured to store portions of data used by the other components of the system 100, as will be described in greater detail below.

In some embodiments, the database 114 comprises starting data 116 and output data 118. Generally, the starting data 116 comprises data and metadata from the source data program. Using the above example, the starting data 116 may include, but is not limited to, one or more time entries and/or scheduling requests from one or more associates entered into a timekeeping program.

Generally, the output data 118 comprises a final result of the batch processes performed on the starting data 116 by the serverless functions in the on-demand cloud computing environment 106. For example, in the case of time entry and scheduling data, the output data 118 may include time entries reconciled with approvals from an HR program (e.g., the output data program 124) and stored in a format readable by and accessible by the output data program 124 (e.g., to execute payroll functions based on approved employee time records).

The on-demand cloud computing or serverless computing environment 106 includes modules for performing batch processing including an event bus 108, a workflow orchestration module 110, and a plurality of containerized applications 112. The event bus 108 acts as a job scheduler and serves to trigger the start of a batch process. The trigger may be routinely scheduled (e.g., every minute or every hour) or event triggered (e.g., receipt of a signal from the source data 122 program indicating a change in the starting data 116). The workflow orchestration module 110 ensures that each step of the batch process is executed in order and may repeat steps if execution fails and/or provide notifications regarding completion of failure of each step. The steps of the batch process can be performed by containerized applications 112 wherein the workflow orchestration module 110 initializes each containerized application to perform a function in a determined order. For example, the workflow orchestration module 110 may only initiate a second containerized application 112 after successful completion of a first containerized application's 112 function. Such an arrangement is useful where order of the steps is important and one step may depend on the output of the prior step.

In the example discussed above, the event bus 108 may be triggered a regular intervals (e.g., hourly) and the workflow orchestration module 110 can initiate a first containerized application 112 that functions to pull time entry data taken from the source data program 122 and stored in the starting data database 116 and write the time entry data to a second database. Upon successful completion of the first step, the workflow orchestration module 110 can initiate a second containerized application 112 to pull time approval data from the output data program 124 (e.g., the HR program) and perform a reconciliation between the approval data and the time entry data from the source data program 122 and write a new record of approved time. Upon successful creation of the approved time data, the workflow orchestration module 110 may initiate a third containerized application 112 that prepares an approved time record in a format accepted by the output data program 124 and send that data output data program 124 (e.g., HR program) for payroll processing. Successful completion of the last step can trigger the workflow orchestration module 110 to end the batch process and await the next trigger from the event bus 108.

The on-demand cloud computing or serverless computing environment 106 may generally refer to a cloud computing execution model in which the cloud provider allocates machine resources on demand, wherein the described modules (e.g., event bus 108, a workflow orchestration module 110, and a plurality of containerized applications 112) are hosted remotely by a third party and do not reside on the customer or user's servers. Such “serverless” applications provides advantages to the user in that they are freed from capacity planning, configuration, management, maintenance, fault tolerance, or scaling of containers, VMs, or physical servers. Resources are not held in volatile memory and the computing is done in short bursts with the results persisted to storage. When an app is not in use, there are no computing resources allocated to the app, thus providing more efficient use of user resources.

An exemplary on-demand cloud computing or serverless computing environment 106 compatible with systems and methods of the invention includes AWS Lambda (Amazon Web Services, Seattle, WA) in which the event bus 108 may comprise AWS EventBridge, the workflow orchestration service may comprise AWS Step Functions, and one or more of the containerized applications may be executed using AWS Fargate, a serverless compute engine for containers that works with Amazon Elastic Container Service (ECS) and Amazon Elastic Kubernetes (EKS), either of which can be used for any of the plurality containerized applications 112. Other on-demand cloud computing or serverless computing environments 106 include Azure serverless services (Microsoft Corporation, Redmond, Washington) and Workflows on Google Cloud (Google LLC, Mountain View California).

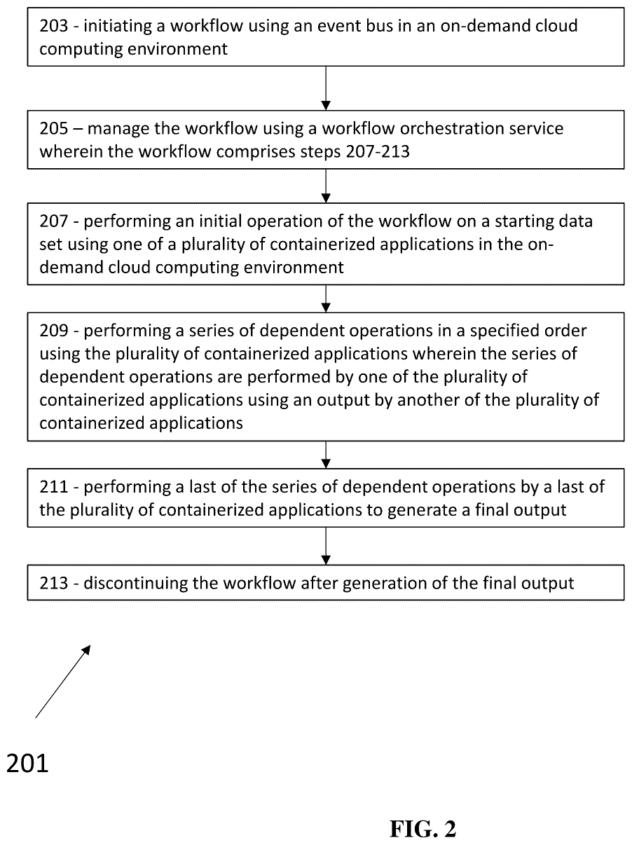

FIG. 2 shows an exemplary method 201 for batch processing in an on-demand cloud computing environment. An event bus such as AWS EventBridge initiates 203 a workflow consisting of various steps (207-213). A workflow orchestration system such as AWS Step Functions manages 205 the workflow, running each of several processes in the workflow (207-213) in a determined order. The workflow consists of performing 207 an initial operation of the workflow on a starting data set using one of a plurality of containerized applications in the on-demand cloud computing environment, performing 209 a series of dependent operations in a specified order using the plurality of containerized applications wherein the series of dependent operations are performed by one of the plurality of containerized applications using an output by another of the plurality of containerized applications, and then performing 211 a last of the series of dependent operations by a last of the plurality of containerized applications to generate a final output. The workflow orchestration system can then discontinue 213 the workflow after generation of the final output.

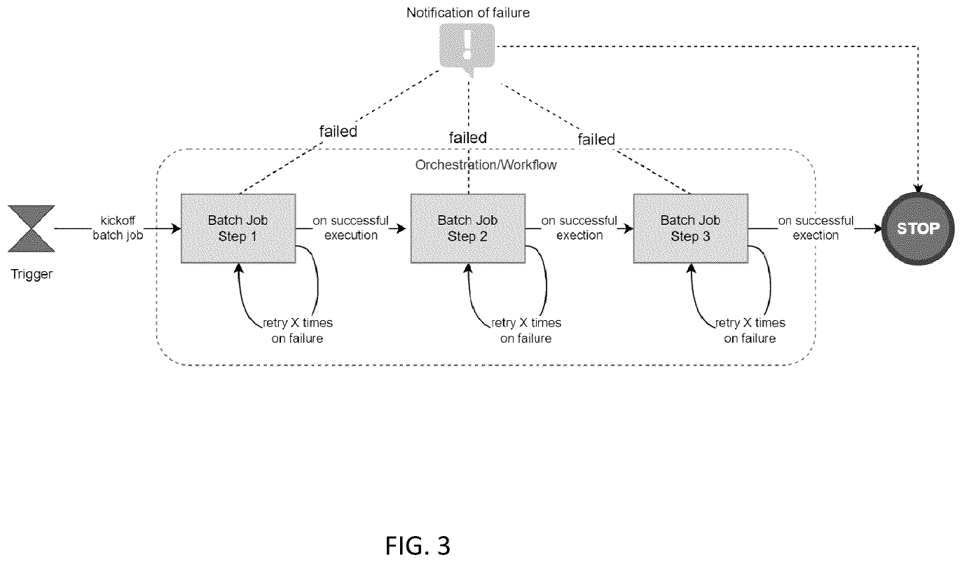

FIG. 3 shows an exemplary batch processing workflow according to various embodiments. As shown, multi-step batch processing is performed where a choreographed sequence is required to ensure that one specific task/job has completed before another task/job has been triggered (e.g., where execution order matters). A trigger kicks off the batch job and Step 1 runs until completed. If an error occurs, Step 1 is retried a max number of X times (where X can be selected by a user or administrator and may different for each Step). When retry=X times, the system can notify of a failure (e.g., by pushing a notification via e-mail or other messaging service to an administrator and stop the batch job). On successful execution of Step 1, the system proceeds to Step 2. Step 2 will then run until completed and if an error occurs, will retry a max of X times. After retrying X times, if the step has not completed successfully the system will notify of failure and stop the batch job as above. On successful execution of Step 2, the system will proceed to Step 3 and so on until all steps are completed in order. The batch job will then stop.

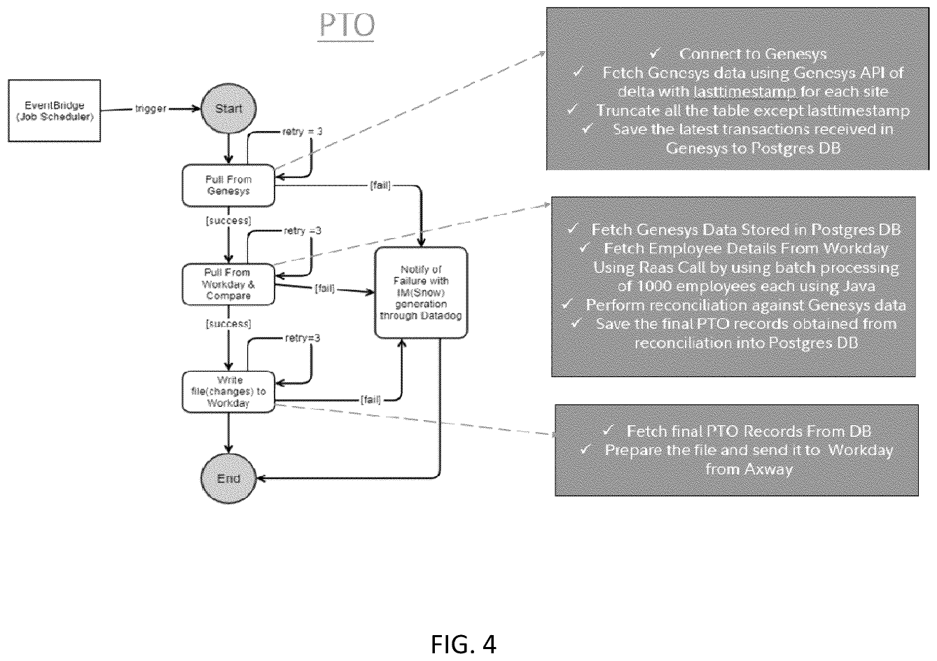

FIG. 4 shows an exemplary batch processing workflow for processing time paid time off requests wherein paid time off (PTO) requests are entered via a call center management software platform available from Genesys Cloud Services, Inc., Menlo Park, California and HR management including scheduling and time off approval is performed using software available from Workday, Inc. Pleasanton, California. In the AWS Lambda serverless environment, EventBridge, acting as the event bus or job scheduler, triggers the start of the batch job consisting of three steps, each of which may be performed by a containerized application through ECS. The first operation pulls data from the Genesys platform including connecting to Genesys, fetching PTO request data from Genesys based on associated time stamps to capture new entries since the last successful completion of the batch job. The data can be pulled using a Genesys API. The first operation can truncate the table to remove any data that has previously been recorded and then save the remaining, new data to a database such as a PostgreSQL database. Progression through the operations in proper order can be managed by a workflow orchestration system such as AWS Step Functions.

The workflow orchestration system can detect failures or errors in the various steps and only proceed from one to the other after successful completion of the preceding operation. The system can retry the step if it fails a selected number of times (e.g., 3 times in the example depicted in FIG. 4). If any step fails, the workflow orchestration system can send a notification (e.g., via instant message through a logging service such as Datadog cloud monitoring (Datadog, Inc., New York, NY)) and then end the batch job. In the depicted example, the second operation includes fetching the Genesys data stored in the first operation from the database and fetching employee details (e.g., approvals of time entries for payroll land approved PTO requests from managers) from Workday. The employee details can be retrieved using Raas Call for example and can be batched into, for example, 1000 employees at a time using Java. The second operation can then reconcile the employee details against the Genesys data from step 1 and save the final PTO records into another database. The third operation can include fetching those final PTO records from the database and preparing a file in the correct format for processing by Workday and send that file to Workday (e.g., using Axway managed file transfer, Axway, Inc., Puteaux, France). Upon completion of the last step, the workflow orchestration system can stop the workflow until triggered again by the event bus at which time the batch job can start over again.

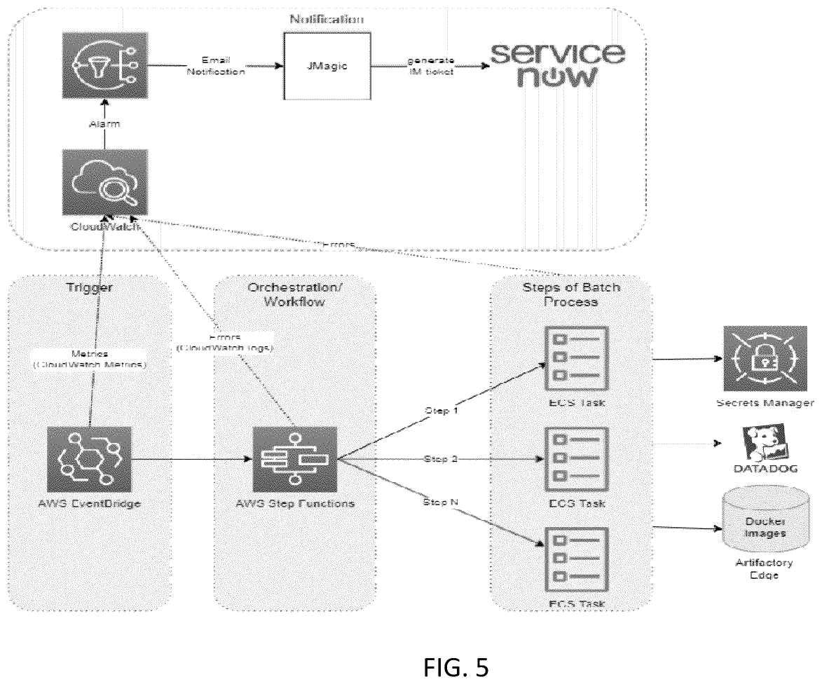

FIG. 5 shows an exemplary system organized in the AWS Lambda environment for serverless batch processing. AWS EventBridge is used to trigger the batch job which is then orchestrated by AWS Step Functions. The workflow consists of a series of steps performed using ECS containerized applications which in turn communicate with databases, an edge node (e.g., Artifactory Edge available from JFrog, Sunnyvale, California), a cloud monitoring service (e.g., Datadog), and/or a database credentials manager (e.g., AWS Secrets Manager to store security information for the various programs the applications may interact with such as Genesys or Workday as discussed above). Each of the event bus and workflow orchestration system can report errors via, for example CloudWatch Metrics or Logs (Amazon Web Services).

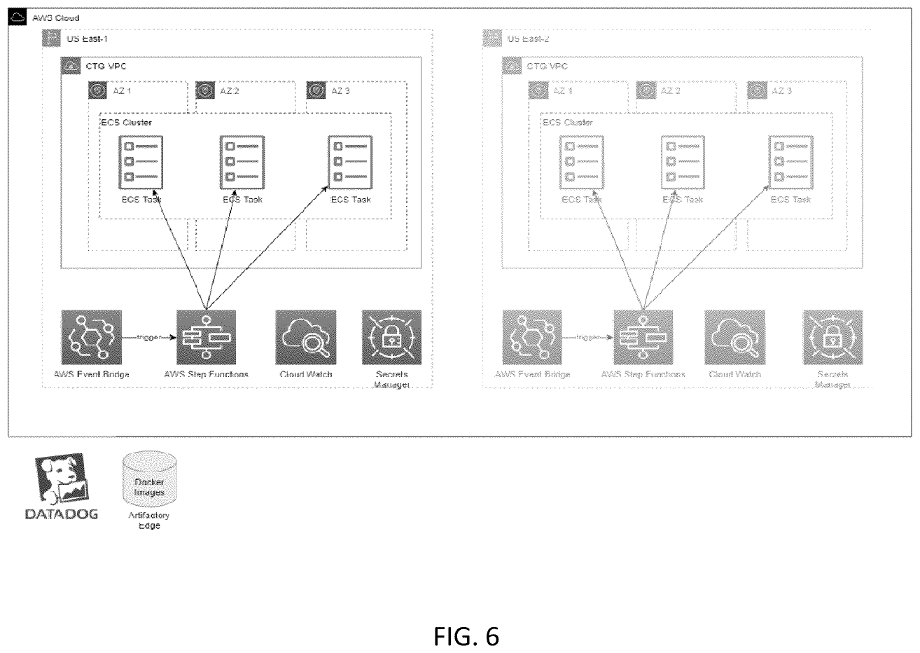

FIG. 6 shows redundancy in an exemplary system organized in the AWS Lambda environment for serverless batch processing in which the systems are redundantly distributed across regions.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for batch processing in an on-demand cloud computing environment comprising an event bus, a workflow orchestration service, and a plurality of containerized applications, the method comprising:
initiating a workflow using the event bus;
managing the workflow using the workflow orchestration service to:
perform an initial operation of the workflow on a starting data set using one of the plurality of containerized applications;
perform a series of dependent operations in a specified order using the plurality of containerized applications wherein the series of dependent operations are performed by one of the plurality of containerized applications using an output by another of the plurality of containerized applications;
perform a last of the series of dependent operations by a last of the plurality of containerized applications to generate a final output; and
discontinue the workflow after generation of the final output.

2. The computerized method of claim 1, further comprising monitoring each of the plurality of containerized applications and retrying the dependent operation until the dependent operation successfully completes or a threshold retry limit is reached.

3. The computerized method of claim 2, wherein the monitoring and retrying steps are performed by the workflow orchestration service.

4. The computerized method of claim 2, wherein the monitoring and retrying steps are performed by each of the plurality of containerized applications.

5. The computerized method of claim 2, further comprising, performing a recovery action when the threshold retry limit is reached.

6. The computerized method of claim 5, wherein the recovery action comprises sending a failure notification, logging a failure notification in a database.

7. The computerized method of claim 1, wherein the event bus comprises AWS EventBridge, the workflow orchestration service comprises AWS Step Functions, and one or more of the containerized applications are executed using AWS Fargate.

8. The computerized method of claim 1, wherein the distributed batch processing comprises time off and payroll processing and the event bus initiates the workflow at regular intervals.

9. The computerized method of claim 8, wherein the starting data set comprises time worked and time off requests entered by users since the workflow was last initiated,
the initial operation performed by a first of the plurality of containerized applications comprises:
retrieving the starting data set from a time entry program using an application programming interface to communicate with the time entry program; and
updating a time entered database with the starting data;
a first of the series of successive, dependent operations:
retrieves time entered data from the time entered database;
retrieves time worked and time off approvals from a time approval program using a web service;
reconciles the time entered data with the time worked and time off approvals to create a final payroll record; and
saves the final payroll record to a payroll database; and
the last of the series of dependent operations comprises:
retrieving the final payroll record from the payroll database;
formatting the final payroll record in an acceptable format for a payroll program; and
sending the formatted final payroll record to the payroll program as the final output.

10. The computerized method of claim 9, wherein the regular intervals are hourly.

11. A computer system for batch processing, the system comprising, an on-demand cloud computing environment, an event bus, a workflow orchestration service, and a plurality of containerized applications,
wherein the event bus is operable to initiate a workflow and the workflow orchestration service is operable to control the workflow and stop the workflow after generation of a final output,
wherein the workflow comprises performing an initial operation on a starting data set followed by a series of successive, dependent operations, in a specified order, using the plurality of containerized applications,
wherein each of the series of dependent operations is performed by one of the plurality of containerized applications using an output by another of the plurality of containerized applications; and
wherein a last of the series of dependent operations performed by a last of the plurality of containerized applications generates the final output.

12. The computer system of claim 1, wherein the workflow orchestration service is further operable to monitor each of the plurality of containerized applications and retry the dependent operation until the dependent operation successfully completes or a threshold retry limit is reached.

13. The computer system of claim 12, wherein the workflow orchestration service is further operable to perform a recovery action when the threshold retry limit is reached.

14. The computer system of claim 1, wherein one or more of the plurality of containerized applications are further operable to retry their dependent operation until their dependent operation successfully completes or a threshold retry limit is reached.

15. The computer system of claim 14, wherein one or more of the plurality of containerized applications are further operable to perform a recovery action when the threshold retry limit is reached.

16. The computer system of claim 15, wherein the recovery action comprises sending a failure notification, logging a failure notification in a database.

17. The computer system of claim 1, wherein the event bus comprises AWS EventBridge, the workflow orchestration service comprises AWS Step Functions, and one or more of the containerized applications are executed using AWS Fargate.

18. The computer system of claim 1, wherein the distributed batch processing comprises time off and payroll processing and the event bus is operable to initiate the workflow at regular intervals.

19. The computer system of claim 18, wherein the starting data set comprises time worked and time off requests entered by users since the workflow was last initiated,
the initial operation performed by a first of the plurality of containerized applications comprises:
retrieving the starting data set from a time entry program using an application programming interface to communicate with the time entry program; and
updating a time entered database with the starting data;
a first of the series of successive, dependent operations is operable to:
retrieve time entered data from the time entered database;
retrieve time worked and time off approvals from a time approval program using a web service;
reconcile the time entered data with the time worked and time off approvals to create a final payroll record; and
save the final payroll record to a payroll database; and
the last of the series of dependent operations comprises:
retrieving the final payroll record from the payroll database;
formatting the final payroll record in an acceptable format for a payroll program; and
sending the formatted final payroll record to the payroll program as the final output.

20. The computer system of claim 19, wherein the regular intervals are hourly.
